(19) United States
(12) Patent Application Publication
(10) Pub. No.: US 2025/0384330 A1
(43) Pub. Date: Dec. 18, 2025

(54) AI PROMPT REFINEMENT AND AI RESPONSE EDITABILITY MANAGEMENT

(71) Applicant: Microsoft Technology Licensing, LLC, Redmond, WA (US)

(72) Inventors: Vlad RISCUTIA, Redmond, WA (US); Ryan LAWRENCE, Redmond, WA (US)

(73) Assignee: Microsoft Technology Licensing, LLC, Redmond, WA (US)

(21) Appl. No.: 18/741,907

(22) Filed: Jun. 13, 2024

(51) Int. Cl. G06N 20/00; G06F 9/451

(52) U.S. Cl. CPC G06N 20/00; G06F 9/451

(57) ABSTRACT

A data processing system implements iteratively receiving a first prompt requesting a generative model to generate digital content, and subsequent prompt(s) requesting the model to further process the digital content; constructing a system prompt including the first prompt, the subsequent prompt(s), and instructions to the model to iteratively update the first prompt based on the subsequent prompt(s), and subsequently to generate the digital content based on a single updated first prompt; providing the system prompt to the model and receive the digital content; and providing the digital content to a client device. The system implements storing a prompt and a response generated by the model in a first application; causing the client device to present the prompt and the response in a read-only view; receiving a user selection to convert the response to editable; and converting the response to editable and inserting the editable response in a collaboration application.

### BACKGROUND

Generative artificial intelligence (AI) refers to a class of AI techniques and models designed to generate content based on prompts. A prompt can be text, audio, video, structured files, and the like that a user wants to use to generate output. Generative AI models are trained on vast amounts data to understand the input and generate outputs that reflect the style and characteristics of the data they were trained on. One area of particular concern in the field of generative AI is the efficiency in generating and processing prompts, as well as saving the prompts and responses in an application for users to re-run. Another area of particular concern is a dilemma of keeping an AI-generated response read-only for re-running a respective prompt or editable for users to edit collaboratively. Hence, there is a need for finding ways to improve prompts and responses processing efficiency and quality in generative AI systems.

### SUMMARY

An example data processing system according to the disclosure includes a processor and a machine-readable medium storing executable instructions. The instructions when executed cause the processor alone or in combination with other processors to perform operations including iteratively receiving, via a user interface of a client device, a first prompt requesting a generative model to generate digital content, and one or more subsequent prompts requesting the generative model to further process the digital content; constructing, via a prompt construction unit, a system prompt by appending the first prompt and the one or more subsequent prompts to a first instruction string, the first instruction string including instructions to the generative model to iteratively update the first prompt based on the one or more subsequent prompts into a single updated first prompt, and subsequently to generate the digital content based on the single updated first prompt; providing, via the prompt construction unit, as an input the system prompt to the generative model and receiving as an output the digital content from the generative model; and providing the digital content to the client device to be presented on a user interface of the client device.

An example method implemented in a data processing system includes iteratively receiving, via a user interface of a client device, a first prompt requesting a generative model to generate digital content, and one or more subsequent prompts requesting the generative model to further process the digital content; constructing, via a prompt construction unit, a system prompt by appending the first prompt and the one or more subsequent prompts to a first instruction string, the first instruction string including instructions to the generative model to iteratively update the first prompt based on the one or more subsequent prompts into a single updated first prompt, and subsequently to generate the digital content based on the single updated first prompt; providing, via the prompt construction unit, as an input the system prompt to the generative model and receiving as an output the digital content from the generative model; and providing the digital content to the client device to be presented on a user interface of the client device.

An example non-transitory computer readable medium according to the disclosure on which are stored instructions that, when executed, cause a programmable device to perform functions of iteratively receiving, via a user interface of a client device, a first prompt requesting a generative model to generate digital content, and one or more subsequent prompts requesting the generative model to further process the digital content; constructing, via a prompt construction unit, a system prompt by appending the first prompt and the one or more subsequent prompts to a first instruction string, the first instruction string including instructions to the generative model to iteratively update the first prompt based on the one or more subsequent prompts into a single updated first prompt, and subsequently to generate the digital content based on the single updated first prompt; providing, via the prompt construction unit, as an input the system prompt to the generative model and receiving as an output the digital content from the generative model; and providing the digital content to the client device to be presented on a user interface of the client device.

An example data processing system according to the disclosure includes a processor and a machine-readable medium storing executable instructions. The instructions when executed cause the processor alone or in combination with other processors to perform operations including storing a prompt and a response generated by a generative model based on the prompt as a group in a first application, the first application saving prompts and responses associated with the generative model; causing a user interface of a client device to present in the first application the prompt and the response in a read-only view; receiving, via the user interface, a user selection to convert the response from read-only to editable; and converting the response to editable and inserting the editable response in a collaboration application.

An example method implemented in a data processing system includes storing a prompt and a response generated by a generative model based on the prompt as a group in a first application, the first application saving prompts and responses associated with the generative model; causing a user interface of a client device to present in the first application the prompt and the response in a read-only view; receiving, via the user interface, a user selection to convert the response from read-only to editable; and converting the response to editable and inserting the editable response in a collaboration application.

An example non-transitory computer readable medium according to the disclosure on which are stored instructions that, when executed, cause a programmable device to perform functions of storing a prompt and a response generated by a generative model based on the prompt as a group in a first application, the first application saving prompts and responses associated with the generative model; causing a user interface of a client device to present in the first application the prompt and the response in a read-only view; receiving, via the user interface, a user selection to convert the response from read-only to editable; and converting the response to editable and inserting the editable response in a collaboration application.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a diagram of an example computing environment in which the techniques for providing AI prompt refinement and response management are implemented.

FIGS. 2A-2D are conceptual diagrams of the AI prompt refinement and response management of the system of FIG. 1.

FIGS. 3A-3C are example user interfaces of an AI response editability management approach that implements the techniques described herein.

FIG. 4A is a flow chart of an example process for providing an AI prompt refinement approach according to the techniques disclosed herein.

FIG. 4B is a flow chart of an example process for providing an AI response editability management approach according to the techniques disclosed herein.

FIG. 5 is a block diagram showing an example software architecture, various portions of which may be used in conjunction with various hardware architectures herein described, which may implement any of the described features.

FIG. 6 is a block diagram showing components of an example machine configured to read instructions from a machine-readable medium and perform any of the features described herein.

### DETAILED DESCRIPTION

Due to the proliferation and widespread adoption of generative AI systems, it has become increasingly important to improve prompts and responses processing efficiency and quality in generative AI systems. There are many ways to improve prompt and response processing efficiency in generative AI systems, such as crafting effective prompts (e.g., specific and clear prompts, context provision, prompts in an instructional format), optimizing response generation (e.g., tailored models, temperature control, early stopping with a set limit), prompt engineering, transfer learning, hardware acceleration, and the like.

AI chat sessions can take place on various platforms like messaging apps, websites, or through virtual assistants like Siri or Alexa. There are different types of AI chatbots, some designed for specific tasks like customer service or information retrieval, while others aim for more open-ended and informative conversations. A chatbot can interact with a generative model to create content on-demand for the user. The system maintains a single prompt while a generative model is asked to continuously update the prompt as desired among multiple users on each iteration. The final single prompt (instead of all of the intermediate refined prompts) is sent to the generative model to get a response. This system thus conserves the computation resources for generating responses to the intermediate refined prompts. In essence, the AI prompt refinement empowers users to better interact with generative models, such as more precise control, errors and biases reduction, and the like.

Additionally, the system converts a generative model response into a collaboration application component content for editing, and removes the ability to regenerate the generative model response from the prompt. This avoids destroying prior edits to the generative model response, while leaving other responses non-editable such that a set of prompts can be re-run as desired for different purposes.

Re-running prompts refers to giving a generative model the same prompt again, possibly with slight variations, in order to explore different creative outputs, identify inconsistencies, encourage randomness, re-phrase prompts, or the like. For instance, re-running the prompt with minor tweaks can lead to slightly different creative text formats, like poems or code, each with a unique spin. This allows a user to explore a wider range of creative possibilities. As another example, when a generative model outputs differ significantly upon re-running, it might reveal inconsistencies in its understanding or limitations in its training data. This can be helpful for debugging. For tasks where a bit of randomness is desired, like generating different story ideas, re-running the prompt can introduce some variation in the results, keeping outputs fresh. Re-phrasing prompts involves re-writing an initial user prompt to be clearer or more specific. This aligns with the AI prompt refinement approach discussed earlier.

In one embodiment, the system relates to assistants and an improved interaction model for storing large language model (LLM) prompts and responses in a first application (e.g., an AI note application). In the first application, a single prompt is maintained while the LLM is asked to continuously update the prompt as desired among multiple users on each iteration, and then the final single prompt (instead of all of the intermediate refined prompts) is sent to a LLM to get a response. Another aspect of the improved interaction model involves using a set of prompts that can be re-run as desired to get the respective responses for different inputs. The set of prompts can be further sent in a sequence to re-run the different inputs. However, to provide a way to edit the AI output from the LLM, the improved interaction model converts an LLM response into a collaboration application document content (e.g., Loop® block) for editing, and removes the ability to regenerate the LLM response from the prompt, to avoid destroying prior edits to the LLM response. The technical problem being addressed is that the first application environment must serve multiple users generating multiple prompts to the LLM, and the collective interaction with the LLM is presently inefficient with the number of prompts and interactions needed to accomplish a task. Another aspect includes a set of canonical user experiences (UX) for the more efficient interaction with the LLM in the first application environment that is multi-user and multi-modal.

In short, the system optimizes AI interactions for efficiency, maintainability, and security, potentially across different generative models or platforms, while preserving their functionalities.

A technical benefit of the AI prompt refinement approach provided herein is to improve prompt generation efficiency. The more specific a refined prompt, the less time the generative model needs to spend trying to understand what the user wants. This improves efficiency and saves time by getting the results the user needs faster.

Another technical benefit of the AI prompt refinement approach is increased accuracy and relevance with refined (clear and concise) prompts. By refining prompts, the approach provides clearer instructions and context that ensure the generative model focuses on the right information and delivers outputs that are more accurate and directly relevant to user needs.

Another technical benefit of the AI prompt refinement approach is to reduce bias and errors. Generative models are trained on massive amounts of data, which can contain biases. A well-refined prompt can help to steer the generative models away from biased interpretations and towards a more neutral and objective response.

Another technical benefit of the AI prompt refinement approach is to tailor a generative model in a particular creative direction, for example, by specifying desired tones, styles, or themes within a prompt, resulting in more creative and engaging outputs that align with user vision.

Another technical benefit of this AI prompt refinement approach is to provide a first application layout with different versions of refined prompts in conjunction with the final refined prompt that was sent to a generative model for a response. The presentation of the different versions of refined prompts can enhance prompting creativity and productivity, support prompting analysis, offer personalized learning opportunities for individual user, and the like.

A technical benefit of the AI response editability management approach provided herein is to combine benefits of both a first application and a collaboration application. The first application stores prompts for users to re-run, or to iterate on an individual prompt and refine it in multiple turns (potentially by multiple users). The collaboration application supports the users to convert a read-only AI-generated response in the AI first application into an editable response in the collaboration application. These features among the overall process details described below in the disclosure provide a novel solution from both a technical and functional standpoint. These and other technical benefits of the techniques disclosed herein will be evident from the discussion of the example implementations that follow.

The term “turn” or “chat turn,” in one example, refers to a conversation exchange which contains both a user question and a reply from an AI chatbot.

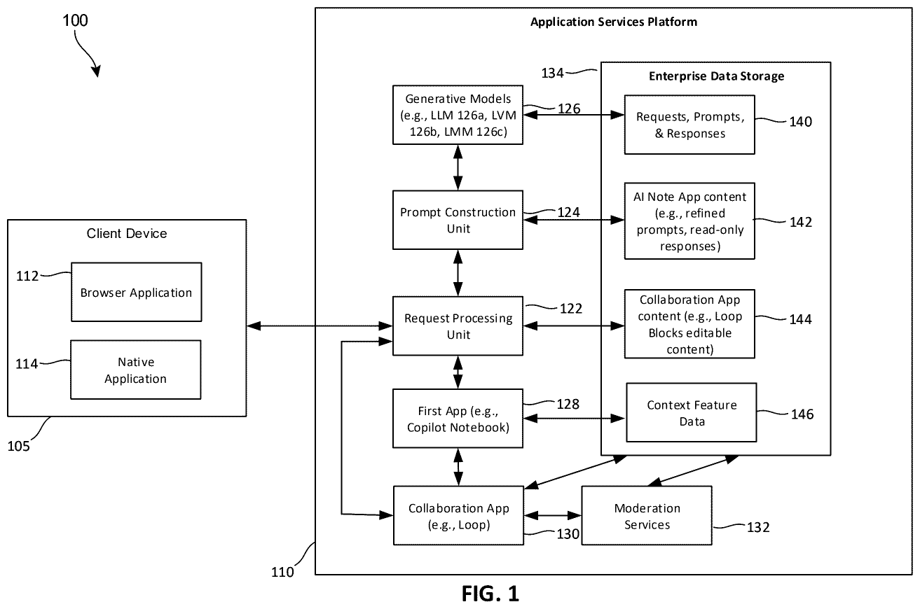

FIG. 1 is a diagram of an example computing environment 100 in which the techniques herein may be implemented. The example computing environment 100 includes a client device 105 and an application services platform 110. The application services platform 110 provides one or more cloud-based applications and/or provides services to support one or more web-enabled native applications on the client device 105. These applications may include but are not limited to AI content generation applications, presentation applications, website authoring applications, collaboration platforms, communications platforms, and/or other types of applications in which users may create, view, and/or modify content. In the implementation shown in FIG. 1, the application services platform 110 also applies generative AI to refine prompts and to manage response editability, according to the techniques described herein. In one embodiment, the application services platform 110 is independently implemented on the client device 105. In another embodiment, the client device 105 and the application services platform 110 communicate with each other over a network (not shown) to implement the system. The network may be a combination of one or more public and/or private networks and may be implemented at least in part by the Internet.

The client device 105 is a computing device that may be implemented as a portable electronic device, such as a mobile phone, a tablet computer, a laptop computer, a portable digital assistant device, a portable game console, and/or other such devices in some implementations. The client device 105 may also be implemented in computing devices having other form factors, such as a desktop computer, vehicle onboard computing system, a kiosk, a point-of-sale system, a video game console, and/or other types of computing devices in other implementations. While the example implementation illustrated in FIG. 1 includes a single client device 105, other implementations may include a different number of client devices that utilize services provided by the application services platform 110.

The computing devices may include virtually any type of general- or specific-purpose computing devices with data processing units. For example, a computing device may be a user device such as a desktop computer, a laptop computer, a tablet computer, a display device, a camera, a printer, or a smartphone. Likewise, a computing device may also be a server device such as an application server computer, a virtual computing host computer, or a file server computer. Likewise, the computing device may be an example of any of the devices, a device within any of the distributed systems, illustrated in or referred to in any of the following figures, as discussed in greater detail below.

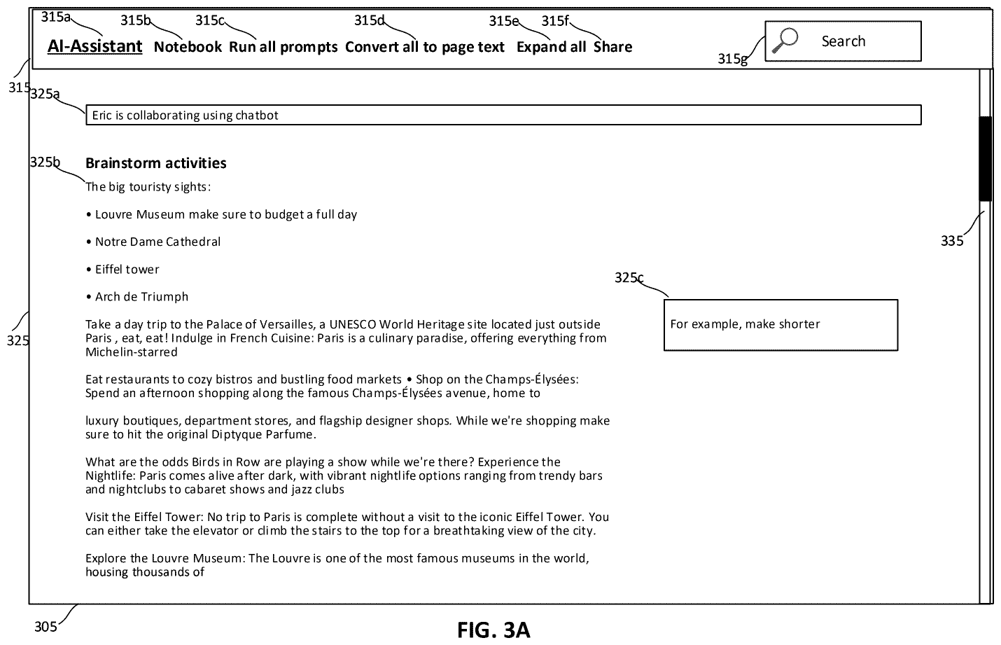

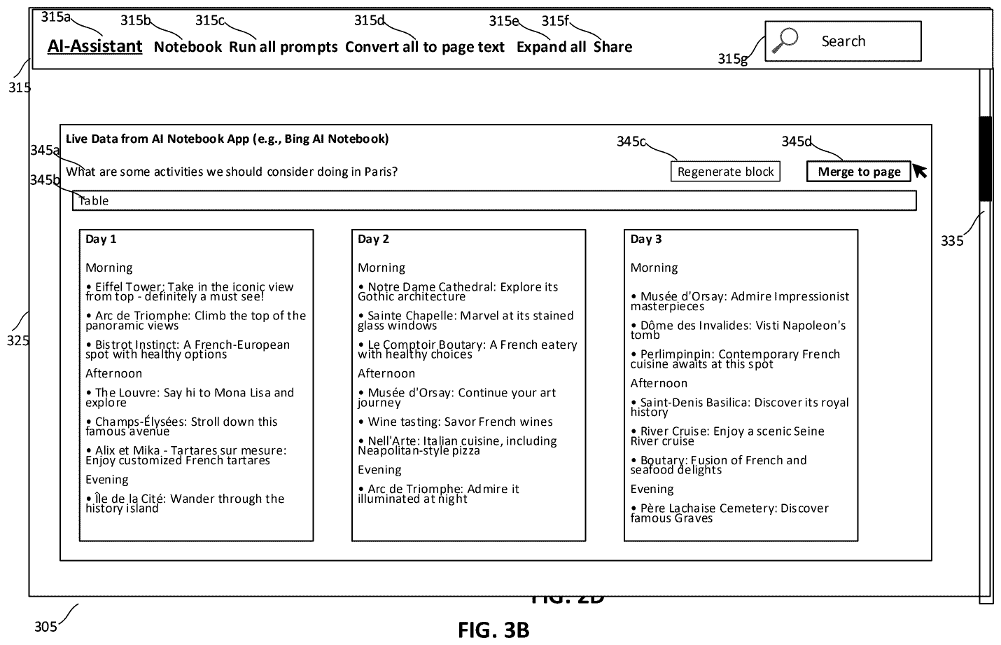

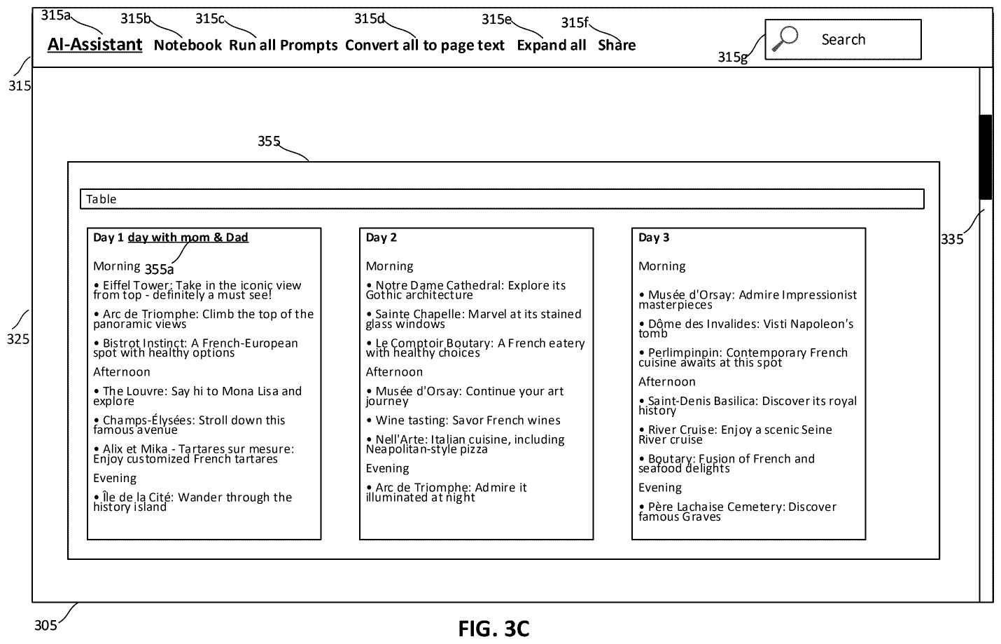

The client device 105 includes a native application 114 and a browser application 112. The native application 114 is a web-enabled native application, in some implementations, which enables users to view, create, and/or modify content. The web-enabled native application utilizes services provided by the application services platform 110 including but not limited to creating, viewing, and/or modifying various types of content and obtaining content data source(s) for creating and/or modifying the content. The native application 114 implements a user interface 305 shown in FIGS. 3A-3C in some implementations. In other implementations, the browser application 112 is used for accessing and viewing web-based content provided by the application services platform 110. In such implementations, the application services platform 110 implements one or more web applications, such as the browser application 112, that enables users to view, create, and/or modify content and to obtain content data for creating and/or modifying content. The browser application 112 implements the user interface 305 shown in FIGS. 3A-3C in some implementations. The application services platform 110 supports both the native application 114 and the browser application 112 in some implementations, and the users may choose which approach best suits their needs.

In one embodiment, the application services platform 110 includes a request processing unit 122, a prompt construction unit 124, generative models 126, a first application 128, and a collaboration application 130. In other embodiments, the application services platform 110 also includes moderation services 132 and an enterprise data storage 134.

The request processing unit 122 is configured to receive requests from the native application 114 and/or the browser application 112 of the client device 105. The requests may include but are not limited to requests to create, view, and/or modify content of interest (e.g., emails, letters, resumes, summaries, translation, reports, poems, articles, stories, blog posts, movie scripts, image, music, video in various styles, video games, code snippets, and the like), and/or sending prompts to a generative models 126 to generate content of interest according to the techniques provided herein. The request processing unit 122 also coordinates communication and exchange of data among components of the application services platform 110 as discussed in the examples which follow.

In one embodiment, the generative models 126 include a generative model trained to generate content (e.g., textual, spreadsheet, chart, report, audio, image, video, and the like) in response to prompts input by a user via the native application 114 or via the web. For instance, the generative models 126 are implemented using a large language model (LLM) in some implementations. Examples of such models include but are not limited to a Generative Pre-trained Transformer 3 (GPT-3), GPT-4 model. For instance, the generative models 126 are implemented using a multimodal model (e.g., GPT-40) in some implementations. Developing an AI model capable of generating content of interest requires training on large and diverse datasets, thereby ensuring that the generated content are relevant and accurately reflect the content of interest. Other implementations may utilize machine learning models or other generative models to generate content of interest according to contextual features of the content and/or preferences of a user.

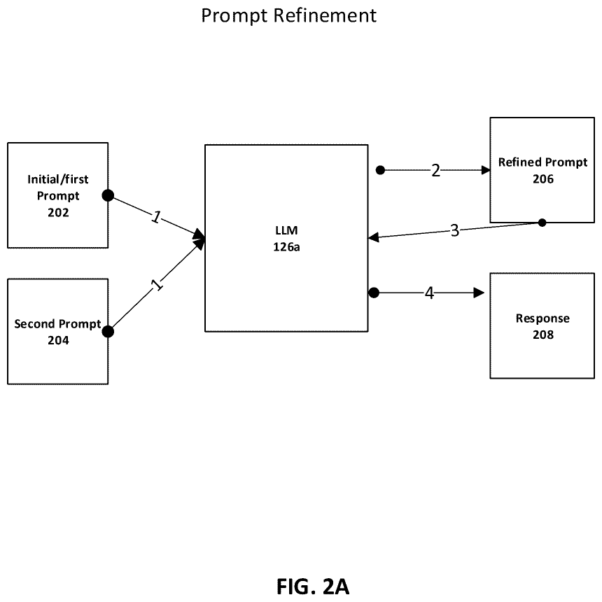

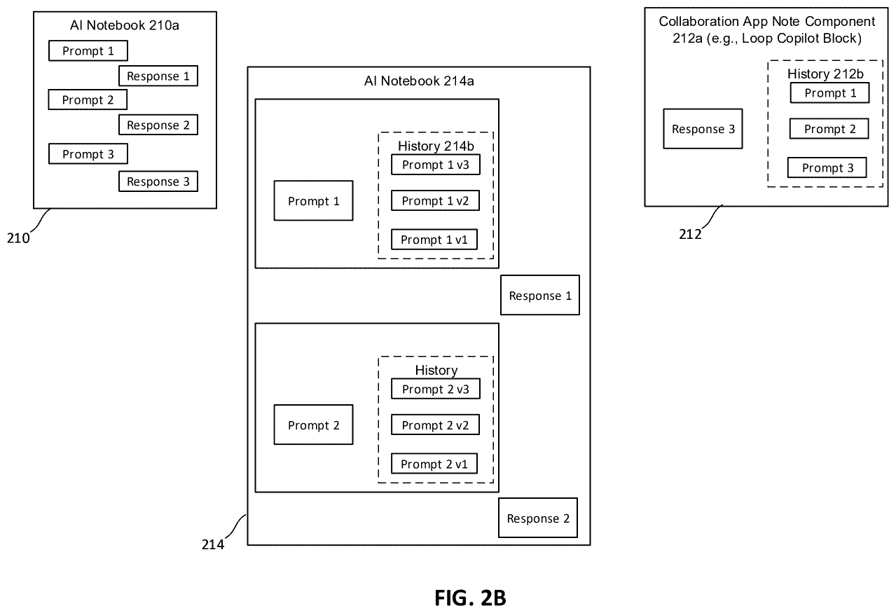

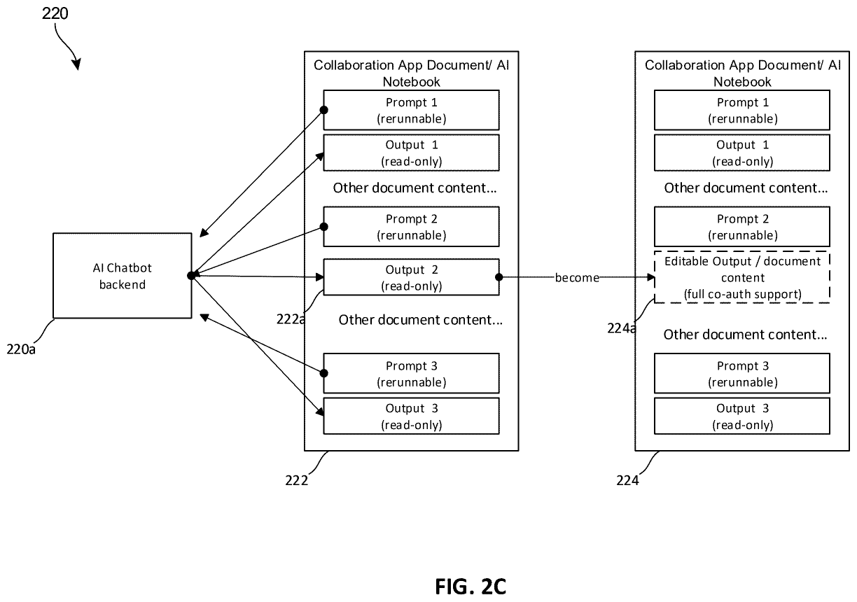

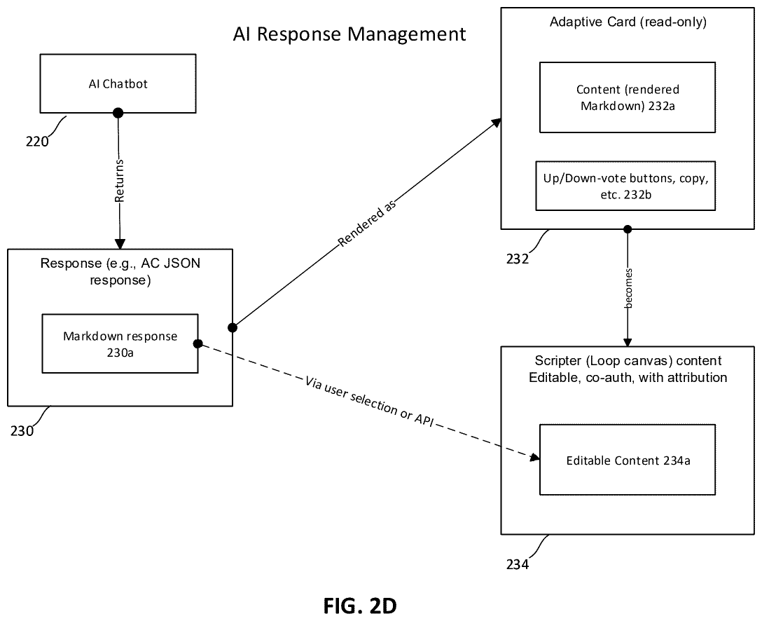

FIGS. 2A-2B are conceptual diagrams of the AI prompt refinement of the system of FIG. 1. In one scenario, to support multi-turn/multi-user prompt iteration, the system maintains a single prompt, and updates the prompt when the user(s) iterate. For example, in FIG. 2A, an initial/first user ask/prompt 202 is “Tell me 3 facts about llamas”. Rather than sending the first user prompt 202 to a LLM 126a (e.g., GPT-3 or the like) to get a response, the system sends the first prompt 202 with a second user prompt 204 (e.g., “Make them funny facts”) to the LLM 126a (Steps 1) to refine the first prompt 202 and the second prompt 204 into a refined prompt 206 (e.g. “Tell me 3 funny facts about llamas”—Step 2), then send the refine prompt 206 to the LLM 126a (Step 3) to generate a response 208 (Step 4). Alternatively, a large multimodal model (LMM) 126c (e.g., GPT4-o or the like) is used in place of the LLM 126a.

On the next iteration (“Keep them sentence-long”), the refined prompt gets refined again to become “Tell me 3 sentence-long funny facts about llamas”. The key change here is moving from a chat-like interaction to a new model that maintains a single prompt and ask the LLM 126a to continuously refine/update the first prompt on each iteration, based on a system prompt (e.g., Table 1). The latest prompt and response are saved in an AI notebook 142 maintained by the first application 128 for the user(s). As a function of the AI notebook 142, the user(s) can re-run all prompts in the AI notebook 142 to reproduce all responses. This makes it easy to re-run a multi-turn/multi-user prompt, since a single prompt can be easily reproduced. The system can also chain several of these multi-turn refined prompts in a first application (e.g., the first application 128) and re-run the whole session.

TABLE 1
Combine the following prompt and subsequent refinement into a single
prompt that can be sent to a large language model to get an equivalent
response.
Prompt: #PROMPT.
Refinement: #REFINEMENT.
Respond with just the combined prompt, nothing before or after it.
Example:
First refinement
Prompt
Combine the following prompt and subsequent refinement into a single
prompt that can be sent to a large language model to get an equivalent
response.
Prompt: “Tell me 3 facts about llamas”.
Refinement: “Make them funny facts”.
Respond with just the combined prompt, nothing before or after it.
Response:
“Tell me 3 funny facts about llamas.”
Second refinement
Combine the following prompt and subsequent refinement into a single
prompt that can be sent to a large language model to get an equivalent
response.
Prompt: “Tell me 3 funny facts about llamas”.
Refinement: “Make them shorter”.
Respond with just the combined prompt, nothing before or after it.
Response:
“Tell me 3 short and funny facts about llamas.”

An AI notebook or the first application stores prompts and responses as a personal archive of a user's AI chat interactions, making it easier to revisit past ideas or helpful responses. For instance, the AI notebook acts as a dedicated space within an AI chatbot where a user can store past interactions. This is different from the general way the AI copilot stores data for improvement and/or training. The AI notebook likely stores prompts and responses as clear pairings, making it easy for a user to revisit past interactions and reference specific prompts or the generated outputs/responses. In addition, a user can control over what goes into the user's notebook, for example, by adding, editing, or deleting entries as needed. In one embodiment, the AI notebook stores data within the AI chatbot, likely separate from other applications of the user. AI notebook entries are not inherently designed for sharing with others, but the user may copy and share the content manually.

FIG. 2B show several user interfaces (UIs) of different AI chats storage approaches implemented by different applications. For example, a UI 210 shows a runnable AI notebook 210a (e.g., Bing Copilot's Notebook) containing a set of prompts and responses in one chat session. For example, a UI 210 shows the runnable AI notebook 210a containing a set of prompts and responses in one chat session. The session starts with sending the prompt 1 into the LLM 126a to generate response 1. Then prompt 2 is sent into the LLM 126a to generate response 2. Lastly, prompt 3 is sent into the LLM 126a to generate response 3. When prompts are sent within a chat session, the LLM 126a builds a context of the conversation, by referencing previous prompts to shape a later response to a current prompt. For example, the three prompts are designed for a competitive analysis of some company, and the system cab re-run same analysis for different company.

The existing approach in the UI 210 generates three responses, instead of just one response as the AI prompt refinement approach in an UI 214. Although both approaches call the LLM 126a for the identical number of times, a prompt refining call uses less computation resources than a response generation call. In addition, the LLM 126a processes a prompt refining call more quickly than a response generation call. Therefore, the AI prompt refinement approach improves the processing efficiency as well as saves computation resources.

In another implementation, a UI 212 shows a note component 212a (e.g., Loop® Copilot® block) of the collaboration application 130 (e.g., Loop®) showing the set of prompts (e.g., Prompt 1, Prompt 2, Prompt 3) and only the last response (e.g., Response 3) of the same chat session in one screen for a user to select and re-run. Microsoft Loop® provides a digital workspace for collaboration, and Loop® blocks are the individual building components within Loop® that can be text boxes, checklists, tables, images, even attachments or polls. The entire Loop® application functions like a canvas. A user can freely arrange and organize Loop® blocks in a Loop® document, creating a visual representation of a project or document. A generic Loop® block is designed for real-time collaboration with flexibility and interactivity, and can contain various elements like text, code snippets, checklists, tables, attachments (e.g., images or documents). A user can arrange and resize Loop® blocks freely within a Loop® canvas, fostering collaboration and information organization. Multiple users can edit the content within a Loop® block simultaneously.

A Loop® Copilot® block contains AI chat related elements like prompts and responses. In this example, the Loop® Copilot® block stores the full set of responses of the chat session, but shows the last response in the UI 212. A user can click via a prompt history 212b to bring back the previous LLM responses. The Loop® Copilot® block has UI affordances to allow users to look at previous prompts and responses, edit the response(s), and the like.

However, the AI notebook UI 210 and the collaboration app note component UI 212 are at odds. For instance, an individual AI notebook serves as a stand-alone personal archive (not intended to share), while Loop® blocks work seamlessly across various applications and are intended for collaborative sharing. With a list of prompts and responses (as in the Loop® Copilot® block case), re-running implies sending Prompt 1 again to the LLM 126a, get Response 1, sending this back to the LLM 126a with Prompt 2 and so on, which is slow and inefficient. On the other hand, the ability to iterate on a prompt, potentially with multiple co-authors, is valuable. Therefore, the system combines the features of the UI 210 and the UI 212 into the UI 214 shown as an AI notebook 214a by introducing the multiple versions of the refined prompts generated as discussed in FIG. 2A. In one embodiment, Prompt 1 v1 (e.g., the first prompt 202), Prompt 1 v2 (e.g., the refined prompt 206), Prompt 1 v3 (e.g., a subsequent refined prompt) are saved in a prompt history 214b in place of Prompt 1, Prompt 2, Prompt 3, and the last refined prompt (e.g., Prompt 1 v3, i.e., Prompt 1) is saved in place of the last response (e.g., Response 3) in the collaboration app note component UI 212, as Prompt 1 block. By analogy, Prompt 2 block is generated accordingly. The system then uses Prompt 1 block, Prompt 2 block, and the like to replace Prompt 1, Prompt 2, or the like in the Notebook UI 210 to provide the UI 214. A user can click on any of the components in the UI 214 to re-run the prompt to get a respective LLM response.

Comparing with the AI notebook UI 210 and the collaboration app note component UI 212, the specific notebook layout in UI 214 additionally provides different versions of refined prompts with the final refined prompt sent to a generative model for a response. The different versions of refined prompts can enhance user prompting creativity and productivity, support prompting analysis, offer personalized learning opportunities for individual users, and the like.

With the AI prompt refinement approach, the system gets the benefits of both the first application (e.g., Notebook®) and a collaboration application document content (e.g., Loop® block)—a first application containing multiple prompts which users can re-run for different inputs, and to iterate on an individual prompt and refine it in multiple turns, potentially by multiple users.

The AI prompt refinement approach offers several advantages when interacting with generative models such as increased accuracy and relevance with clear and concise prompts, reduced bias with well-refined prompts, improved efficiency, tailoring generative models in a particular creative direction, and the like.

FIGS. 2C-2D are conceptual diagrams of an AI response editability management approach of the system of FIG. 1. In the collaboration application (e.g., Loop® App), a user can open a component/block to produce text based on a prompt which can then be refined/coauthored with other users. This collaboration application document (e.g., Loop® Copilot® block) maintains a prompt history and provides attribution (e.g., hovering over a word will show whether it was produced by the AI chatbot or edited later by a user). In the first application 128 (e.g., Bing AI Notebook), there is a list of prompts which produce outputs/responses as cards (e.g., read-only Adaptive Cards).

Adaptive Cards are a format for displaying interactive content within apps and services. An Adaptive Card is a customizable card that can contain any combination of text, speech, images, buttons, and input fields. Specifically, the Cards are platform-agnostic snippets of UI, written in JSON, that apps and services can openly exchange. When delivered to a specific app, the JSON is transformed into native UI that automatically adapts to its surroundings. It helps design and integrate light-weight UI for all major platforms and frameworks. In the AI chat storage context, the Adaptive Card is used to hold prompts, responses, and other content (e.g., user votes). Users can upvote, downvote, download responses, and the like, but the content is read-only. This is especially important in the notebook scenario as a user may want to re-run the list of prompts to reproduce responses, in which case custom user edits to the response are not allowed. The underlying tech stack is also different across Loop® (using a collaborative text editor for rendering) and Bing AI response (using a card).

In FIG. 2C, the AI response editability management approach applies a multimodal way (e.g., a Bing AI Notebook/Loop® App integration”) to realize values in both scenarios: to have a Notebook of prompts to be re-run for different inputs (e.g., the same financial analysis prompt on different stocks/inputs, same travel planning, such as good restaurants, sight-seeing spots, and the like for each vacation day, etc.), and to turn an output/response (e.g., a read-only “Output 2” 222a) in a collaboration app document/AI notebook integration UI 222 (e.g., Bing AI Notebook/Loop® App integration UI) as supported by a backend 220a of an AI Chatbot 220 into an editable artifact (e.g., an editable Output/document content 224a with full coauthoring support) in a collaboration app document/AI notebook integration UI 224 to share with other user(s) who can edit it in a Loop® component.

In one embodiment, the AI response editability management approach starts with a prompt and a read-only view of its response (as a card similar to an existing Bing AI response). The user can edit/re-run the prompt to re-generate the response. The AI response editability management approach converts the response into editable content upon a user request. For example, once the user chooses to convert the response, the AI response editability management approach translates the card into a collaboration application document (e.g., Loop® document) content with attribution (e.g., initially attributing all content to the AI chatbot). At a final stage, one or more users can edit the editable content in the Loop® document, while the AI response editability management approach removes the ability to regenerate the response from the prompt (which would cause the loss of the user edits).

Behind the scene, the AI chatbot 220 (e.g., Bing AI) returns a response 230 (e.g., an AC JSON response with JSON content containing a Markdown response 230a) which gets rendered into an Adaptive Card 232. The Adaptive Card 232 shows non-editable content (e.g., content (rendered Markdown) 232a), and Up/Down-vote buttons, Copy button, etc. 232b. Markdown adds rich text formatting (e.g., bold, italic, ordered list, unordered list, hyperlinks, and the like) to the Cards.

Based on a user-explicit action (e.g., clicking a UI button by the user), the AI response editability management approach takes the same Markdown response 230a and inserts it into a Loop Canvas. Alternatively, the AI response editability management approach provides an application programming interface (API) for the user to insert content into the Loop® document. Within the Bing shell, the AI response editability management approach can load Loop, and then insert the response content into the Loop canvas by converting the response content into a Loop text block that supports rich text editing, such as bold, italics, headings, and even bulleted or numbered lists. At this point, the response content becomes editable content 234a as a part of a Loop® document (i.e., Scripter (Loop canvas) content 234) and allows coauthoring, attribution, and the like. However, the response 230 can no longer be re-generated (to avoid destroying user edits to the corresponding content in the Loop document).

More generally, the AI response editability management approach provides a multimodal AI output by taking a response from a generative model, and providing several different views on it with different capabilities. In FIG. 2D, there are two views on the same underlying response 230: the read-only reproducible card 222a and a co-authorable text (or other data type, such as images, video, and the like) block 224a. The AI response editability management approach can also provide some affordance (e.g. a button) that allows users to explicitly change modes (e.g., going from read-only to editable content).

At a high level, the AI response editability management approach merges two scenarios: a list of chained prompts that can be re-run with slightly different inputs (e.g., from AI Notebook) and an editable AI output (e.g., in Loop Copilot). For example, the AI response editability management approach gives users a seamless progression from “I am researching something with Copilot” to “I want to create an artifact and share with others”. The AI response editability management approach offers a merged experience between these two takes on integrating AI, as a re-runnable chain of prompts (e.g., re-running prompts with slight variations to explore different creative outputs, identify inconsistencies, encourage randomness, re-phrase prompts, or the like), and a collaborative block of AI-produced content (e.g., for co-authoring based on an AI-generated response). The AI response editability management approach also solves for the following dilemma: if this content is editable from the start, re-running the prompt will destroy user edits; but if content is always read-only, it's hard to go from AI interaction to a sharable artifact.

Co-authoring based on an AI-generated response offers a unique blend of human creativity and AI's strengths, leading to several advantages such as enhanced creativity and innovation, improved efficiency and productivity, boosted accuracy and factual consistency, tailored content and style, accessibility and scalability, and the like. AI can inject new ideas by suggesting unexpected connections, or generating different creative text formats. AI can handle repetitive tasks like research, content formatting, or grammar checks. AI can access and process vast amounts of information, ensuring factual accuracy and reducing the risk of errors in your writing. A user can guide the AI with specific prompts and style preferences, thereby tailoring the content. Additionally, AI can help with large-scale content creation projects where consistent quality and volume are needed.

With the AI response editability management approach, the system supports a user to select between the Notebook and the Loop block, either to re-run for different prompts in the Notebook for the respective responses, or to edit a response in a Loop block, potentially by multiple users.

Once the prompt construction unit 124 interprets that the user prompt is for generating the content, the prompt construction unit 124 can formulate meta-prompt(s) for generating the content. The prompt construction unit 124 can divide different data type components of the content (e.g., text, image, audio, video, tables, and the like), and selectively choose data type(s) to generate textual data for generating respective content components.

The data is tokenized before being fed to the LLM 126a. As such, the AI-based content generation can integrate the LLM 126a with various sources of input data, such as documents, meeting transcripts, and recordings. Beside standard text, audio, and video formats, the AI-based content generation can semantically analyze other data types such as the structured file content (e.g., Comma-Separated Values, CSV), and store tabular data like spreadsheets, where each row represents a record, and commas (or other delimiters) separate values within a row).

In another embodiment, the AI-based content generation builds a data orchestration system based on a multi-agent AI conversation framework (e.g., AutoGen®), where each Agent covers specific sources of input data (i.e., each one of the app-specific data sources integrated with the Copilot® chatbot), and deploys respective LLMs and tools (e.g., sound/speech analysis tools, visual analysis tools, and the like). AutoGen® is an open-source, community-driven project that provides a multi-agent conversation framework as a high-level abstraction. The AI-based content generation applies handoff implementation for each specific application so that the application can communicate properly with a respective Agent from the AutoGen-based orchestration framework.

The prompt construction unit 124 may reformat or otherwise standardize the information to be included in the prompt to a standardized format that is recognized by the generative models 126. For instance, the content to be semantically analyzed may be in a non-digital format (e.g., a paper report). The generative models 126 are trained using training data in this standardized format, in some implementations, and utilizing this format for the prompts provided to the generative models 126 may improve the predictions provided by the generative models 126.

In some implementations, when the content of interest is already in the format directly processible by the generative models 126, the prompt construction unit 124 does not need to convert the content of interest. In other implementations, when the content of interest is not in the format directly processible by the generative models 126, the prompt construction unit 124 converts the content of interest to the format directly processible by the generative models 126. Some common standardized formats recognized by a language model include plain text, Markdown, HTML, JSON, XML, and the like. In one embodiment, the system converts content data into JSON, which is a lightweight and efficient data-interchange format. In addition, ChatML document format is used to provide document context information to ChatGPT, and ChatML may be used which is a JSON-based format that allows a user to specify the conversational history, dialog state, and other contextual information.

The prompt construction unit 124 then constructs a system prompt based on the content data and/or the meta prompt, and outputs the system prompt to the language model 126a to process different data type components of the content of interest. Depending on the content of interest requested by a user, the system can fetch content data uploaded from one or more of the following (but not limited to) a virtual meeting and collaboration application (e.g., Microsoft Teams®), digital whiteboard application(s) (e.g., Microsoft Whiteboard®), employee experience application(s) (e.g., Microsoft Viva®), online collaboration application(s) (e.g., Microsoft Loop®), calendar application(s) (e.g., Microsoft Outlook®), email application(s) (e.g., Microsoft Outlook® email), task management application(s) (e.g., Microsoft To Do®), and team-work planning application(s) (e.g., Microsoft Planner®), software development application(s) (e.g., Microsoft Azure®), enterprise accounting and sales application(s) (e.g., Microsoft Dynamic®, Salesforce®, or the like), social media application(s) (e.g., Facebook®, Google® Blogger®, or the like), an online encyclopedia and/or databases (e.g., Wikipedia®), and the like. In some implementations, the user can also customize content data sources according to the user's preference(s), work style(s), and the like. For example, while the prompt construction unit 124 constructs the system prompt (e.g., Table 1), the system prompt can be adapted or extended based on different implementations.

In some implementations, the prompt construction unit 124 may submit further prompts to re-generate content of interest(s) based on user feedback. The prompt construction unit 124 can store contextual feature data 146 (e.g., user preferences, user activities, and the like) for the duration of the user session in which the user uses the native application 114 or the browser application 112. A technical benefit of this approach is that the contextual feature data 146 does not need to be retrieved each time that the user submits a natural language prompt to generate content of interest. The request processing unit 122 maintains user session information in a persistent memory of the application services platform 110 and retrieves the contextual feature data 146 from the user session information in response to each subsequent prompt submitted by the user. The request processing unit 122 then provides the newly received user prompt and the contextual feature data 146 to the prompt construction unit 124 to construct the prompt as discussed in the preceding examples.

All the above-discussed requests, prompts and responses 140, content data of the AI note application 142 (e.g., refined prompts, read-only responses, and the like), collaboration application content data 144 (e.g., Loop® Blocks editable content), and contextual feature data 146 can be stored in the enterprise data storage 134. The enterprise data storage 134 can be physical and/or virtual, depending on the entity's needs and IT infrastructure. Examples of physical enterprise data storage systems include network-attached storage (NAS), storage area network (SAN), direct-attached storage (DAS), tape libraries, hybrid storage arrays, object storage, and the like. Examples of virtual enterprise data storage systems include virtual SAN (vSAN), software-defined storage (SDS), cloud storage, hyper-converged Infrastructure (HCl), network virtualization and software-defined networking (SDN), container storage, and the like.

Since content creation involves use of a generative AI which utilizes user content such as user voice and videos, personal data privacy and data ownership guidelines are taken into consideration. There are security and privacy considerations and strategies for using open source generative models with enterprise data, such as data anonymization, isolating data, providing secure access, securing the model, using a secure environment, encryption, regular auditing, compliance with laws and regulations, data retention policies, performing privacy impact assessment, user education, performing regular updates, providing disaster recovery and backup, providing an incident response plan, third-party reviews, and the like. By following these security and privacy best practices, the example computing environment 100 can minimize the risks associated with using open source generative models while protecting enterprise data from unauthorized access or exposure.

In an example, the application services platform 110 can store enterprise data separately from generative model training data, to reduce the risk of unintentionally leaking sensitive information during model generation. The application services platform 110 can limit access to generative models and the enterprise data. The application services platform 110 can also implement proper access controls, strong authentication, and authorization mechanisms to ensure that only authorized personnel can interact with the selected model and the enterprise data.

The application services platform 110 can also run the generative models 126 in a secure computing environment. Moreover, the application services platform 110 can employ robust network security, firewalls, and intrusion detection systems to protect against external threats. The application services platform 110 can encrypt the enterprise data and any data in transit. The application services platform 110 can also employ encryption standards for data storage and data transmission to safeguard against data breaches.

Moreover, the application services platform 110 can implement strong security measures around the generative models 126, such as regular security audits, code reviews, and ensuring that the model is up-to-date with security patches. The application services platform 110 can periodically audit the generative model's usage and access logs, to detect any unauthorized or anomalous activities. The application services platform 110 can also ensure that any use of open source generative models complies with relevant data protection regulations such as GDPR, HIPAA, or other industry-specific compliance standards.

The application services platform 110 can establish data retention and data deletion policies to ensure that generated data is not stored longer than necessary, to minimizes the risk of data exposure. The application services platform 110 can perform a privacy impact assessment (PIA) to identify and mitigate potential privacy risks associated with the generative model's usage. The application services platform 110 can also provide mechanisms for training and educating users on the proper handling of enterprise data and the responsible use of generative models. In addition, the application services platform 110 can stay up-to-date with evolving security threats and best practices that are essential for ongoing data protection.

FIGS. 3A-3C are example user interfaces of an AI response editability management approach that implements the techniques described herein. The example user interface shown in FIGS. 3A-3C is a user interface of an AI-based content generation application, such as but not limited to Microsoft Copilot®. However, the techniques herein for providing AI response editability management are not limited to use in the AI-based content generation application and may be used to generate content for other types of applications including but not limited to presentation applications, website authoring applications, collaboration platforms, communications platforms, and/or other types of applications in which users create, view, and/or modify various types of content. Such applications can be a stand-alone application, or a plug-in of any application on the client device 105, such as the browser application 112, the native application 114, and the like. For example, the system can work on the web or within a virtual meeting and collaboration application (e.g., MICROSOFT TEAMS®) or an email application (e.g., OUTLOOK®). The system can be integrated into the MICROSOFT VIVA® platform or could work within a browser (e.g., WINDOWS® EDGE®), or MICROSOFT COPILOT®. The system can also work within a website chat functionality (e.g., the BING® chat functionality).

FIG. 3A shows an example of the user interface 305 of an AI-based content generation application in which the user is interacting with an AI generative model to generate content of interest. The user interface 305 includes a control pane 315, a notebook pane 325 and a scrollbar 335. The user interface 305 may be implemented by the native application 114 and/or the browser application 112.

In some implementations, the control pane 315 includes an AI-Assistant button 315a, a Notebook button 315b, a Run all prompts button 315c, a Convert all to page text button 315d, an Expand all button 315e, a Share button 315f, and a search field 315g. The AI-Assistant button 315a can be selected to provide content generation functions. In some implementations, the notebook pane 325 provides a workspace in which the user can enter prompts in the AI-based content generation application.

User prompts usually describe content that the user would like to have automatically generated by the generative models 126 of the application services platform 110. The application submits the natural language prompt to the application services platform 110 and user information identifying the user of the application to the application services platform 110. The application services platform 110 processes user prompts according to the techniques provided herein to generate and manage generative model responses according to the AI response editability management approach described with respect to FIGS. 2C-2D.

In FIG. 3A a status field 325a, a collaboration workspace 325b to address to a query of: “What are some activities we should consider doing in Paris?”, and a prompt enter box 325c in the notebook pane 325. The status field 325a shows a collaboration status of the workspace users, such as “Eric is collaborating using chatbot.” The collaboration workspace 325b lists several activity ideas for planning a trip to Paris. The prompt enter box 325c shows a suggested prompt for the chatbot, thereby editing the content in the celebration workspace 325b, such as “For example, make shorter.” Upon a user selection of the Run all prompts button 315c, the chatbot runs all the content in the collaboration workspace 325b as prompts and generates a response as shown in FIG. 3B. The notebook pane 325 shows a query 345a: “What are some activities we should consider doing in Paris?”, a response 345b of a 3-day travel itinerary table generated by the chatbot for the query 345a based on the collaboration content, a Regenerate block button 345c, and a Merge to page button 345d. FIG. 3B also shows “Live Data from AI notebook App such as Bing AI Notebook) in the notebook pane 325.

Upon a user selection of the Merge to page button 345d, the read-only response 345b of the 3-day travel itinerary table is converted into an editable page 355 in a Loop® block in FIG. 3C, based on the above described embodiments (e.g., FIGS. 2C-2D). For example, the user added some words 355a “day with mom & dad” into the editable page 355.

In some implementations, the system provides a feedback loop by augmenting thumbs up and thumbs down buttons for each AI-generated content item in the user interface 305. If the user dislikes a response, the system can ask why and use the input to improve the response. A thumbs down click could also prompt the user to indicate whether the response was too long, too short, missing information, and the like.

The user prompts, the responses, and the user feedback are submitted to the application services platform 110 to generate another response using the generative models 126 and/or to improve the generative models 126. The AI-based content generation thus incorporates user feedback in real-time or in substantially real-time, and allows user inputs via intuitive user interfaces.

In some implementations, the application services platform 110 includes the moderation services 132 that analyze user prompt(s), user feedbacks, and responses generated by the generative models 126, to ensure that potentially objectionable or offensive content is not generated or utilized by the application services platform 110.

If potentially objectionable or offensive content is detected in the user prompt(s), the user feedbacks, and the AI-generated responses, the moderation services 132 provides a blocked content notification to the client device 105 indicating that the prompt(s), the user data is blocked from forming the system prompt. In some implementations, the request processing unit 122 discards any user data that includes potentially objectionable or offensive content and passes any remaining content that has not been discarded to the request processing unit 122 to be provided as an input to the prompt construction unit 124. In other implementations, the prompt construction unit 124 discards any content that includes potentially objectionable or offensive content and passes any remaining content that has not been discarded to the generative models 126 as an input.

In one embodiment, the prompt construction unit 124 submits the user prompt(s), and/or the system prompt to the moderation services 132 to ensure that the prompt does not include any potentially objectionable or offensive content. The prompt construction unit 124 halts the processing of the user prompt(s), and/or the system prompt in response to the moderation services 132 determining that the user prompt(s) and/or the responses includes potentially objectionable or offensive content. As discussed in the preceding examples, the moderation services 132 generates a blocked content notification in response to determining that the user prompt(s), and/or the system prompt includes potentially objectionable or offensive content, and the notification is provided to the native application 114 or the browser application 112 so that the notification can be presented to the user on the client device 105. For instance, the user may attempt to revise and resubmit the user prompt(s). As another example, the system may generate another system prompt after removing task data associated with the potentially objectionable or offensive content.

The moderation services 132 can be implemented by a machine learning model trained to analyze the content of these various inputs and/or outputs to perform a semantic analysis on the content to predict whether the content includes potentially objectionable or offensive content. The moderation services 132 can perform another check on the content using a machine learning model configured to analyze the words and/or phrase used in content to identify potentially offensive language/image/sound. The moderation services 132 can compare the language used in the content with a list of prohibited terms/images/sounds including known offensive words and/or phrases, images, sounds, and the like. The moderation services 132 can provide a dynamic list that can be quickly updated by administrators to add additional prohibited terms/images/sounds. The dynamic list may be updated to address problems such as words or phrases becoming offensive that were not previously deemed to be offensive. The words and/or phrases added to the dynamic list may be periodically migrated to the guard list as the guard list is updated. The specific checks performed by the moderation services 132 may vary from implementation to implementation. If one or more of these checks determines that the textual content includes offensive content, the moderation services 132 can notify the application services platform 110 that some action should be taken.

In some implementations, the moderation services 132 generates a blocked content notification, which is provided to the client device 105. The native application 114 or the browser application 112 receives the notification and presents a message on a user interface of the application that the user prompt received by the request processing unit 122 could not be processed. The user interface provides information indicating why the blocked content notification was issued in some implementations. The user may attempt to refine a natural language prompt to remove the potentially offensive content. A technical benefit of this approach is that the moderation services 132 provides safeguards against both user-created and model-created content to ensure that prohibited offensive or potentially offensive content is not presented to the user in the native application 114 or the browser application 112.

As mentioned, the application services platform 110 complies with privacy guidelines and regulations that apply to the usage of user data included in the content to be semantically analyzed to ensure that users have control over how the application services platform 110 utilizes their data. The user is provided with an opportunity to opt into the application services platform 110 to allow the application services platform 110 to access the user data and enable the generative models 126 to generate a response according to user consent. In some implementations, the first time that an application, such as the native application 114 or the browser application 112 presents the data analysis assistant to the user, the user is presented with a message that indicates that the user may opt into allowing the application services platform 110 to use user data included in the content to support the content generation functionality. The user may opt into allowing the application services platform 110 to access all or a subset of user data included in the content to be semantically analyzed in a video. Furthermore, the user may modify their opt-in status at any time by selectively opting into or opting out of allowing the application services platform 110 from accessing and utilizing user data from the content as a whole or individually.

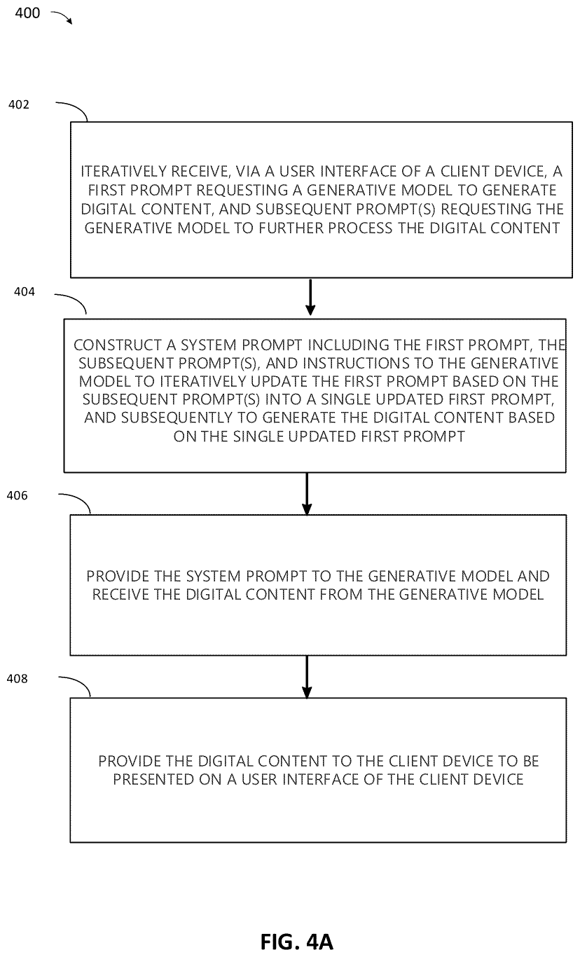

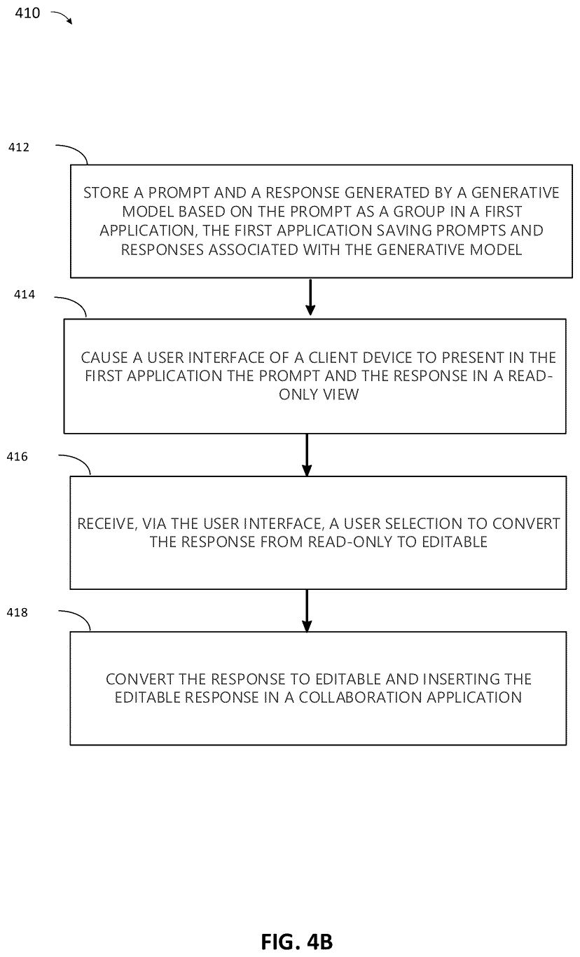

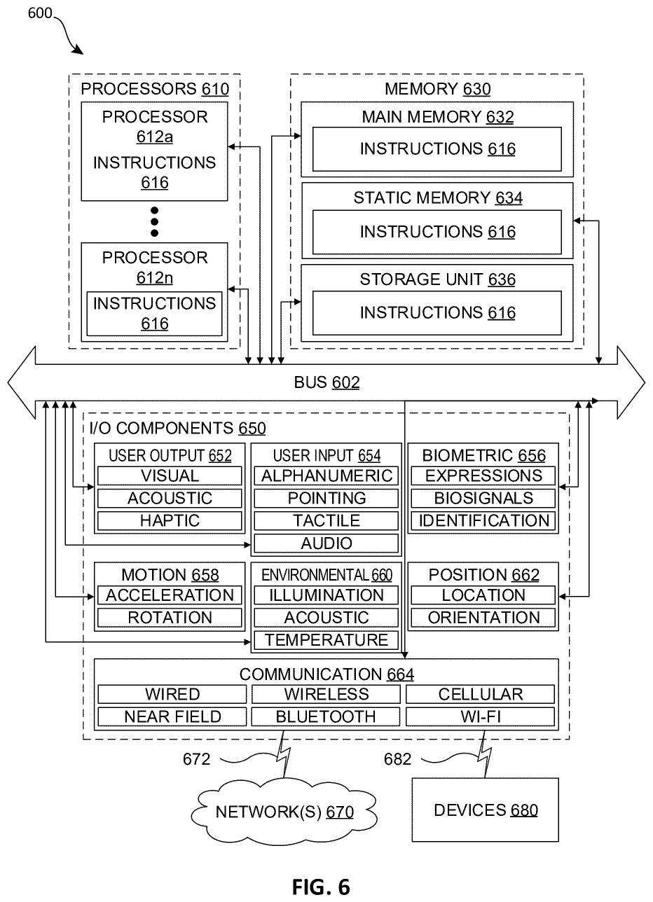

FIG. 4A is a flow chart of an example process for the AI prompt refinement approach according to the techniques disclosed herein. The process 400 can be implemented by the application services platform 110 or its components shown in the preceding examples. The process 400 may be implemented in, for instance, an example machine including a processor and a memory as shown in FIG. 6. As such, the application services platform 110 can provide means for accomplishing various parts of the process 400, as well as means for accomplishing embodiments of other processes described herein in conjunction with other components of the example computing environment 100. Although the process 400 is illustrated and described as a sequence of steps, it is contemplated that various embodiments of the process 400 may be performed in any order or combination and need not include all the illustrated steps.

In one embodiment, for example, in step 402, a request processing unit (e.g., the request processing unit 122) iteratively receives, via a client device (e.g., the client device 105) a first prompt (e.g., “Tell me 3 facts about llamas”, the first prompt 202 in FIG. 2A, the Prompt 1 v1 in FIG. 2B, or the like) requesting a generative model (e.g., the LMM 126c) to generate digital content, and one or more subsequent prompts (e.g., “Make them funny facts”, “Keep them sentence-long”, the second prompt 204 in FIG. 2A, the Prompt 1 v2 in FIG. 2B, or the like) requesting the generative model to further process the digital content. For example, the generative model is a language model, a vision model, or a multimodal model. The client device can be used by a developer (e.g., for programming) or an end user (e.g., for work content generation).

In some implementations, the first prompt are received via a software application, and the software application is a virtual meeting and collaboration application (e.g., Microsoft Teams®), a digital whiteboard application (e.g., Microsoft Whiteboard®), an employee experience application (e.g., Microsoft Viva®), an online collaboration application (e.g., Microsoft Loop®), a calendar application (e.g., Microsoft Outlook®), an email application (e.g., Microsoft Outlook® email), a task management application (e.g., Microsoft To Do®), a team-work planning application (e.g., Microsoft Planner®), a software development application (e.g., Microsoft Azure®), an enterprise accounting and sales application (e.g., Microsoft Dynamic®), a social media application (e.g., Facebook®), or an online encyclopedia and/or database (e.g., Wikipedia®).

In step 404, a prompt construction unit (e.g., the prompt construction unit 124) constructs a system prompt (e.g., Table 1) by appending the first prompt and the one or more subsequent prompts to a first instruction string, the first instruction string including instructions to the generative model to iteratively update the first prompt based on the one or more subsequent prompts into a single updated first prompt (e.g., “Tell me 3 sentence-long funny facts about llamas”, the refined prompt 206 in FIG. 2A, the Prompt 1 in FIG. 2B, or the like), and subsequently to generate the digital content (e.g., the response 208 in FIG. 2A, the Response 1 in FIG. 2B, or the like) based on the single updated first prompt.

In step 406, the prompt construction unit provides as an input the system prompt to the generative model and receiving as an output the digital content from the generative model. In another embodiment, the LLM 126a handles most of the instructions in the first instruction string except for generating the visual content (e.g., image, video, diagram, and the like) that is left for a large vision model (LVM) 126b (e.g., Dalle-E), and/or the LMM 126c (e.g., GPT4-o, Sora, or the like) to handle.

In step 408, the request processing unit provides the digital content to the client device to be presented on a user interface (e.g., the user interface 305 in FIGS. 3A-3C) of the client device. In one embodiment, the request processing unit stores the first prompt and the one or more subsequent prompts as a group in a first application (e.g., the first application 128) that saves prompts and responses associated with the generative model; and causes the user interface of the client device to present in the first application the first prompt and the one or more subsequent prompts in a read-only view (e.g., a view based on the Adaptive Card 232 in FIG. 2D) to be selected for re-run. For example, the request processing unit receives, via the user interface, a user selection to re-run at least one of the first prompt and the one or more subsequent prompts. As a result, the prompt construction unit constructs a system prompt by appending the at least one of the first prompt and the one or more subsequent prompts to a second instruction string, the second instruction string including instructions to the generative model to generate a re-run digital content based on the at least one of the first prompt and the one or more subsequent prompts. The prompt construction unit then provides as an input the system prompt to the generative model and receiving as an output the re-run digital content from the generative model. The request processing unit then provides the re-run digital content to the client device to be presented on the user interface of the client device.

In other implementations, the second instruction string further includes instructions to re-run the at least one of the first prompt and the one or more subsequent prompts with variations, and to at least one of explore different outputs, identify inconsistencies, encourage randomness, or re-phrase prompts based on the re-run digital content.

In yet another embodiment, the system incorporates the AI response editability management approach into the AI prompt refinements approach as follows. For instance, the first application works in conjunction with a collaboration application (e.g., the collaboration application 130), and the first prompt and the one or more subsequent prompts are submitted by a plurality of users via the collaboration application. For example, the request processing unit causes the user interface of the client device to present the digital content (e.g., the 3-day travel itinerary table) in an editable view in the collaboration application (e.g., the editable page 355 in a Loop® block in FIG. 3C); and receives, via the editable view, an edited digital content generated based on one or more user edits to the digital content.

In one scenario, the request processing unit causes the user interface of the client device to provide an application programming interface; and receives, via the application programming interface, a user insertion of the digital content into the collaboration application. The insertion causes the user interface of the client device to present the digital content in the editable view in the collaboration application. In another scenario, the request processing unit causes the user interface of the client device to present a user interactive element in the first application; and receives, via the user interface, a user selection of the user interactive element. The user selection of the user interactive element causes the user interface of the client device to present the digital content in the editable view in the collaboration application.

In one embodiment, the request processing unit receives at least one user feedback on the AI-generated responses via the user interface of the client device. For instance, the user feedback is collected via a user selection of at least one of a thumbs-up tab, a thumbs-down tab, a neutral tab, or a generating-more-image tab, a textual input, or a combination thereof. The prompt construction unit constructs a second prompt by appending the feedback and the AI-generated response to a second instruction string, the second instruction string including instructions to the generative model to generate at least another AI-generated response based on the feedback and the AI-generated response, by adjusting one or more attributes of the AI-generated response based on the feedback. The prompt construction unit provides as an input the second prompt to the generative model and receives as an output the other AI-generated response of the digital content from the generative model. The request processing unit provides the other AI-generated response to the client device, and causes the user interface of the client device to present the other AI-generated response.

In another embodiment, the request processing unit causes the user interface to receive a confirmation of the AI-generated response from a user, and causes a publication of the AI-generated response. In some implementations, the request processing unit works in conjunction with the collaboration application 130 to cause the user interface to receive a comment or annotation from a user to edit the AI-generated response, or causes the user interface to present interactive elements for the user to edit the AI-generated response. For instance, the collaboration application 130 works in conjunction with the request processing unit 122 to interact with users through a graphical user interface (GUI), providing a visual workspace for manipulating the AI-generated response.

Therefore, the AI prompt refinement approach improves prompt generation efficiency by getting the results the user needs faster. The more specific a refined prompt, the less time the generative model needs to spend trying to understand what the user wants. In addition, the AI prompt refinement approach increases accuracy and relevance with refined (clear and concise) prompts. The AI prompt refinement approach reduces bias and errors and tailors a generative model in a particular creative direction, via well-refined prompts. The AI prompt refinement approach also provides a first application layout with different versions of refined prompts in conjunction with the final refined prompt that was sent to a generative model for a response, thereby enhancing prompting creativity and productivity, supporting prompting analysis, offering personalized learning opportunities for individual user, and the like.

FIG. 4B is a flow chart of an example process for the AI response editability management approach according to the techniques disclosed herein. The process 410 can be implemented by the application services platform 110 or its components shown in the preceding examples. The process 410 may be implemented in, for instance, the example machine including a processor and a memory as shown in FIG. 6. As such, the application services platform 110 can provide means for accomplishing various parts of the process 410, as well as means for accomplishing embodiments of other processes described herein in conjunction with other components of the example computing environment 100. Although the process 410 is illustrated and described as a sequence of steps, it is contemplated that various embodiments of the process 410 may be performed in any order or combination and need not include all the illustrated steps.

In one embodiment, for example, in step 412, a request processing unit (e.g., the request processing unit 122) stores a prompt and a response generated by a generative model (e.g., the LLM 126a) based on the prompt as a group in a first application (e.g., the first application 128 residing at a client device or in the cloud), the first application saving prompts and responses associated with the generative model (for one or more users, e.g., the UI 210 in FIG. 2B).

In step 414, the request processing unit causes a user interface (e.g., the user interface 305) of a client device (e.g., the client device 105) to present in the first application the prompt and the response in a read-only view (e.g., to be selected for re-run, see a view based on the Adaptive Card 232 in FIG. 2D).

In step 416, the request processing unit receives, via the user interface, a user selection to convert the response from read-only (e.g., the read-only “Output 2” 222a in the collaboration app document/AI Notebook integration UI 222 in FIG. 2C) to editable (e.g., the editable Output/document content 224a in the collaboration app document/AI notebook integration UI 224 in FIG. 2C). In one embodiment, in response to the user selection, the request processing unit causes the user interface of the client device to provide an application programming interface; and receiving, via the application programming interface, a user insertion of the response into the collaboration application. The insertion causes the user interface of the client device to present the editable response in the editable view in the collaboration application. In another embodiment, in response to the user selection, the request processing unit causes the user interface of the client device to present a user interactive element in the first application; and receives, via the user interface, a user selection of the user interactive element. The user selection of the user interactive element causes the user interface of the client device to present the editable response in the editable view in the collaboration application.

In step 418, the request processing unit, the first application, a collaboration application (e.g., the collaboration application 130), or another application/plug-in converts the response to editable and insert the editable response in the collaboration application. The request processing unit causes the user interface of the client device to present the editable response (e.g., the 3-day travel itinerary table) in an editable view (e.g., the editable page 355 in a Loop® block in FIG. 3C) in the collaboration application, and receives, via the editable view, an edited response generated based on one or more user edits to the editable response.

In yet another embodiment, the system incorporates the AI prompt refinements approach into the AI response editability management approach as follows. For instance, the request processing unit receives, via the user interface of the client device, a first prompt (e.g., “Tell me 3 facts about llamas”, the first prompt 202 in FIG. 2A, the Prompt 1 v1 in FIG. 2B, or the like) requesting a generative model to generate a response, and one or more subsequent prompts (e.g., “Make them funny facts”, “Keep them sentence-long”, the second prompt 204 in FIG. 2A, the Prompt 1 v2 in FIG. 2B, or the like) requesting the generative model to further process the response. The prompt construction unit constructs the system prompt (e.g., Table 1) and the one or more subsequent prompts to a first instruction string, the first instruction string including instructions to the generative model to update the first prompt based on the one or more subsequent prompts into an updated first prompt (e.g., “Tell me 3 sentence-long funny facts about llamas”, the refined prompt 206 in FIG. 2A, the Prompt 1 in FIG. 2B, or the like), and to generate the digital content (e.g., the response 208 in FIG. 2A, the Response 1 in FIG. 2B, or the like) based on the updated first prompt. The prompt construction unit then provides as an input the system prompt to the generative model and receiving as an output the response from the generative model; and stores the first prompt and the one or more subsequent prompts as a group in the first application, wherein the prompt includes the group. The request processing unit then causes the user interface of the client device to present in the first application the group in a read-only view (e.g., to be selected for re-run, see a view based on the Adaptive Card 232 in FIG. 2D) to be selected for re-run.

Therefore, the AI response editability management approach combines benefits of both a first application (storing AI prompts/responses) and a collaboration application. The first application stores prompts for users to re-run, or to iterate on an individual prompt and refine it in multiple turns, potentially by multiple users, while the collaboration application supports the users to convert a read-only AI-generated response in the first application into an editable response in the collaboration application. In other words, a user can choose between the first application and the collaboration application, either to re-run different prompts in the first application for the respective responses (read-only), or to edit a response in the collaboration application, potentially by multiple users.

In addition, the AI response editability management approach bridges between a re-runnable chain of prompts (e.g., re-running prompts with slight variations to explore different creative outputs, identify inconsistencies, encourage randomness, re-phrase prompts, or the like), and a collaborative block of AI-produced content (e.g., for co-authoring based on an AI-generated response).

The detailed examples of systems, devices, and techniques described in connection with FIGS. 1-4 are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-4 are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

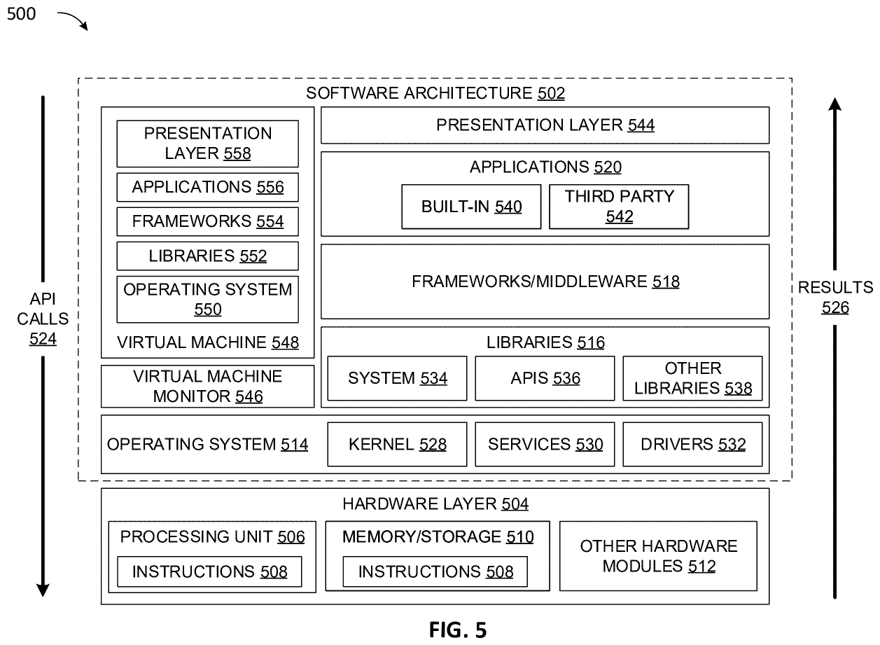

FIG. 5 is a block diagram 500 illustrating an example software architecture 502, various portions of which may be used in conjunction with various hardware architectures herein described, which may implement any of the above-described features. FIG. 5 is a non-limiting example of a software architecture, and it will be appreciated that many other architectures may be implemented to facilitate the functionality described herein. The software architecture 502 may execute on hardware such as a machine 600 of FIG. 6 that includes, among other things, processors 610, memory 630, and input/output (I/O) components 650. A representative hardware layer 504 is illustrated and can represent, for example, the machine 600 of FIG. 6. The representative hardware layer 504 includes a processing unit 506 and associated executable instructions 508. The executable instructions 508 represent executable instructions of the software architecture 502, including implementation of the methods, modules and so forth described herein. The hardware layer 504 also includes a memory/storage 510, which also includes the executable instructions 508 and accompanying data. The hardware layer 504 may also include other hardware modules 512. Instructions 508 held by processing unit 506 may be portions of instructions 508 held by the memory/storage 510.

The example software architecture 502 may be conceptualized as layers, each providing various functionality. For example, the software architecture 502 may include layers and components such as an operating system (OS) 514, libraries 516, frameworks 518, applications 520, and a presentation layer 544. Operationally, the applications 520 and/or other components within the layers may invoke API calls 524 to other layers and receive corresponding results 526. The layers illustrated are representative in nature and other software architectures may include additional or different layers. For example, some mobile or special purpose operating systems may not provide the frameworks/middleware 518.

The OS 514 may manage hardware resources and provide common services. The OS 514 may include, for example, a kernel 528, services 530, and drivers 532. The kernel 528 may act as an abstraction layer between the hardware layer 504 and other software layers. For example, the kernel 528 may be responsible for memory management, processor management (for example, scheduling), component management, networking, security settings, and so on. The services 530 may provide other common services for the other software layers. The drivers 532 may be responsible for controlling or interfacing with the underlying hardware layer 504. For instance, the drivers 532 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 516 may provide a common infrastructure that may be used by the applications 520 and/or other components and/or layers. The libraries 516 typically provide functionality for use by other software modules to perform tasks, rather than interacting directly with the OS 514. The libraries 516 may include system libraries 534 (for example, C standard library) that may provide functions such as memory allocation, string manipulation, file operations. In addition, the libraries 516 may include API libraries 536 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 516 may also include a wide variety of other libraries 538 to provide many functions for applications 520 and other software modules.

The frameworks 518 (also sometimes referred to as middleware) provide a higher-level common infrastructure that may be used by the applications 520 and/or other software modules. For example, the frameworks 518 may provide various graphic user interface (GUI) functions, high-level resource management, or high-level location services. The frameworks 518 may provide a broad spectrum of other APIs for applications 520 and/or other software modules.

The applications 520 include built-in applications 540 and/or third-party applications 542. Examples of built-in applications 540 may include, but are not limited to, a contacts application, a browser application, a location application, a media application, a messaging application, and/or a game application. Third-party applications 542 may include any applications developed by an entity other than the vendor of the particular platform. The applications 520 may use functions available via OS 514, libraries 516, frameworks 518, and presentation layer 544 to create user interfaces to interact with users.

Some software architectures use virtual machines, as illustrated by a virtual machine 548. The virtual machine 548 provides an execution environment where applications/modules can execute as if they were executing on a hardware machine (such as the machine 600 of FIG. 6, for example). The virtual machine 548 may be hosted by a host OS (for example, OS 514) or hypervisor, and may have a virtual machine monitor 546 which manages operation of the virtual machine 548 and interoperation with the host operating system. A software architecture, which may be different from software architecture 502 outside of the virtual machine, executes within the virtual machine 548 such as an OS 550, libraries 552, frameworks 554, applications 556, and/or a presentation layer 558.

FIG. 6 is a block diagram illustrating components of an example machine 600 configured to read instructions from a machine-readable medium (for example, a machine-readable storage medium) and perform any of the features described herein. The example machine 600 is in a form of a computer system, within which instructions 616 (for example, in the form of software components) for causing the machine 600 to perform any of the features described herein may be executed. As such, the instructions 616 may be used to implement modules or components described herein. The instructions 616 cause unprogrammed and/or unconfigured machine 600 to operate as a particular machine configured to carry out the described features. The machine 600 may be configured to operate as a standalone device or may be coupled (for example, networked) to other machines. In a networked deployment, the machine 600 may operate in the capacity of a server machine or a client machine in a server-client network environment, or as a node in a peer-to-peer or distributed network environment. Machine 600 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 600 is illustrated, the term “machine” includes a collection of machines that individually or jointly execute the instructions 616.

The machine 600 may include processors 610, memory 630, and I/O components 650, which may be communicatively coupled via, for example, a bus 602. The bus 602 may include multiple buses coupling various elements of machine 600 via various bus technologies and protocols. In an example, the processors 610 (including, for example, a central processing unit (CPU), a graphics processing unit (GPU), a neural processing unit (NPU), a digital signal processor (DSP), an ASIC, or a suitable combination thereof) may include one or more processors 612a to 612n that may execute the instructions 616 and process data. In some examples, one or more processors 610 may execute instructions provided or identified by one or more other processors 610. The term “processor” includes a multi-core processor including cores that may execute instructions contemporaneously. Although FIG. 6 shows multiple processors, the machine 600 may include a single processor with a single core, a single processor with multiple cores (for example, a multi-core processor), multiple processors each with a single core, multiple processors each with multiple cores, or any combination thereof. In some examples, the machine 600 may include multiple processors distributed among multiple machines.

The memory/storage 630 may include a main memory 632, a static memory 634, or other memory, and a storage unit 636, both accessible to the processors 610 such as via the bus 602. The storage unit 636 and memory 632, 634 store instructions 616 embodying any one or more of the functions described herein. The memory/storage 630 may also store temporary, intermediate, and/or long-term data for processors 610. The instructions 616 may also reside, completely or partially, within the memory 632, 634, within the storage unit 636, within at least one of the processors 610 (for example, within a command buffer or cache memory), within memory at least one of I/O components 650, or any suitable combination thereof, during execution thereof. Accordingly, the memory 632, 634, the storage unit 636, memory in processors 610, and memory in I/O components 650 are examples of machine-readable media.

As used herein, “machine-readable medium” refers to a device able to temporarily or permanently store instructions and data that cause machine 600 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 616) for execution by a machine 600 such that the instructions, when executed by one or more processors 610 of the machine 600, cause the machine 600 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 650 may include a wide variety of hardware components adapted to receive input, provide output, produce output, transmit information, exchange information, capture measurements, and so on. The specific I/O components 650 included in a particular machine will depend on the type and/or function of the machine. For example, mobile devices such as mobile phones may include a touch input device, whereas a headless server or IoT device may not include such a touch input device. The particular examples of I/O components illustrated in FIG. 6 are in no way limiting, and other types of components may be included in machine 600. The grouping of I/O components 650 are merely for simplifying this discussion, and the grouping is in no way limiting. In various examples, the I/O components 650 may include user output components 652 and user input components 654. User output components 652 may include, for example, display components for displaying information (for example, a liquid crystal display (LCD) or a projector), acoustic components (for example, speakers), haptic components (for example, a vibratory motor or force-feedback device), and/or other signal generators. User input components 654 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 650 may include biometric components 656, motion components 658, environmental components 660, and/or position components 662, among a wide array of other physical sensor components. The biometric components 656 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 658 may include, for example, acceleration sensors (for example, an accelerometer) and rotation sensors (for example, a gyroscope). The environmental components 660 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 662 may include, for example, location sensors (for example, a Global Position System (GPS) receiver), altitude sensors (for example, an air pressure sensor from which altitude may be derived), and/or orientation sensors (for example, magnetometers).

The I/O components 650 may include communication components 664, implementing a wide variety of technologies operable to couple the machine 600 to network(s) 670 and/or device(s) 680 via respective communicative couplings 672 and 682. The communication components 664 may include one or more network interface components or other suitable devices to interface with the network(s) 670. The communication components 664 may include, for example, components adapted to provide wired communication, wireless communication, cellular communication, Near Field Communication (NFC), Bluetooth communication, Wi-Fi, and/or communication via other modalities. The device(s) 680 may include other machines or various peripheral devices (for example, coupled via USB).

In some examples, the communication components 664 may detect identifiers or include components adapted to detect identifiers. For example, the communication components 664 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 664, such as, but not limited to, geo-location via Internet Protocol (IP) address, location via Wi-Fi, cellular, NFC, Bluetooth, or other wireless station identification and/or signal triangulation.

In the preceding detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article, or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a machine-readable storage medium storing executable instructions that, when executed, cause the processor alone or in combination with other processors to perform operations of:
iteratively receiving, via a user interface of a client device, a first prompt requesting a generative model to generate digital content, and one or more subsequent prompts requesting the generative model to further process the digital content;
constructing, via a prompt construction unit, a system prompt by appending the first prompt and the one or more subsequent prompts to a first instruction string, the first instruction string including instructions to the generative model to iteratively update the first prompt based on the one or more subsequent prompts into a single updated first prompt, and subsequently to generate the digital content based on the single updated first prompt;
providing, via the prompt construction unit, as an input the system prompt to the generative model and receiving as an output the digital content from the generative model; and
providing the digital content to the client device to be presented on a user interface of the client device.

2. The data processing system of claim 1, wherein the machine-readable storage medium further includes instructions configured to cause the processor alone or in combination with other processors to perform at least one of the operations of:
storing the first prompt and the one or more subsequent prompts as a group in a first application that saves prompts and responses associated with the generative model; and
causing the user interface of the client device to present in the first application the first prompt and the one or more subsequent prompts in a read-only view to be selected for re-run.

3. The data processing system of claim 2, wherein the machine-readable storage medium further includes instructions configured to cause the processor alone or in combination with other processors to perform at least one of the operations of:
receiving, via the user interface, a user selection to re-run at least one of the first prompt and the one or more subsequent prompts;
constructing, via the prompt construction unit, a second prompt by appending the at least one of the first prompt and the one or more subsequent prompts to a second instruction string, the second instruction string including instructions to the generative model to generate a re-run digital content based on the at least one of the first prompt and the one or more subsequent prompts;
providing, via the prompt construction unit, as an input the second prompt to the generative model and receiving as an output the re-run digital content from the generative model; and
providing the re-run digital content to the client device to be presented on the user interface of the client device.

4. The data processing system of claim 3, wherein the second instruction string further includes instructions to re-run the at least one of the first prompt and the one or more subsequent prompts with variations, and to at least one of explore different outputs, identify inconsistencies, encourage randomness, or re-phrase prompts based on the re-run digital content.

5. The data processing system of claim 3, wherein the first application works in conjunction with a collaboration application, and the first prompt and the one or more subsequent prompts are submitted by a plurality of users via the collaboration application.

6. The data processing system of claim 5, wherein the machine-readable storage medium further includes instructions configured to cause the processor alone or in combination with other processors to perform at least one of the operations of:
causing the user interface of the client device to present the digital content in an editable view in the collaboration application; and
receiving, via the editable view, an edited digital content generated based on one or more user edits to the digital content.

7. The data processing system of claim 6, wherein the machine-readable storage medium further includes instructions configured to cause the processor alone or in combination with other processors to perform at least one of the operations of:
causing the user interface of the client device to provide an application programming interface; and
receiving, via the application programming interface, a user insertion of the digital content into the collaboration application,
wherein the insertion causes the user interface of the client device to present the digital content in the editable view in the collaboration application.

8. The data processing system of claim 6, wherein the machine-readable storage medium further includes instructions configured to cause the processor alone or in combination with other processors to perform at least one of the operations of:
causing the user interface of the client device to present a user interactive element in the first application; and
receiving, via the user interface, a user selection of the user interactive element,
wherein the user selection of the user interactive element causes the user interface of the client device to present the digital content in the editable view in the collaboration application.

9. The data processing system of claim 1, wherein the client device is used by a developer or an end user.

10. The data processing system of claim 1, wherein the generative model is a language model, a vision model, or a multimodal model.

11. A method comprising:
storing a prompt and a response generated by a generative model based on the prompt as a group in a first application, the first application saving prompts and responses associated with the generative model;
causing a user interface of a client device to present in the first application the prompt and the response in a read-only view;
receiving, via the user interface, a user selection to convert the response from read-only to editable; and
converting the response to editable and inserting the editable response in a collaboration application.

12. The method of claim 11, further comprising:
causing the user interface of the client device to present the editable response in an editable view in the collaboration application.

13. The method of claim 12, further comprising:
receiving, via the editable view, an edited response generated based on one or more user edits to the editable response.

14. The method of claim 12, further comprising:
in response to the user selection, causing the user interface of the client device to provide an application programming interface; and
receiving, via the application programming interface, a user insertion of the response into the collaboration application,
wherein the insertion causes the user interface of the client device to present the editable response in the editable view in the collaboration application.

15. The method of claim 12, further comprising:
in response to the user selection, causing the user interface of the client device to present a user interactive element in the first application; and
receiving, via the user interface, a user selection of the user interactive element,
wherein the user selection of the user interactive element causes the user interface of the client device to present the editable response in the editable view in the collaboration application.

16. The method of claim 12, further comprising:
receiving, via the user interface of the client device, a first prompt requesting a generative model to generate a response, and one or more subsequent prompts requesting the generative model to further process the response;
constructing, via a prompt construction unit, a system prompt by appending the first prompt and the one or more subsequent prompts to a first instruction string, the first instruction string including instructions to the generative model to update the first prompt based on the one or more subsequent prompts into an updated first prompt, and to generate digital content based on the updated first prompt;
providing, via the prompt construction unit, as an input the system prompt to the generative model and receiving as an output the response from the generative model; and
storing the first prompt and the one or more subsequent prompts as a group in the first application, wherein the prompt includes the group.

17. The method of claim 16, further comprising:
causing the user interface of the client device to present in the first application the group in a read-only view to be selected for re-run.

18. A non-transitory computer readable medium on which are stored instructions that, when executed, cause a programmable device to perform functions of:
iteratively receiving, via a user interface of a client device, a first prompt requesting a generative model to generate digital content, and one or more subsequent prompts requesting the generative model to further process the digital content;
constructing, via a prompt construction unit, a system prompt by appending the first prompt and the one or more subsequent prompts to a first instruction string, the first instruction string including instructions to the generative model to iteratively update the first prompt based on the one or more subsequent prompts into a single updated first prompt, and subsequently to generate the digital content based on the single updated first prompt;
providing, via the prompt construction unit, as an input the system prompt to the generative model and receiving as an output the digital content from the generative model; and
providing the digital content to the client device to be presented on a user interface of the client device.

19. The non-transitory computer readable medium of claim 18, wherein the instructions when executed, further cause the programmable device to perform functions of:
storing the first prompt and the one or more subsequent prompts as a group in a first application that saves prompts and responses associated with the generative model; and
causing the user interface of the client device to present in the first application the first prompt and the one or more subsequent prompts in a read-only view to be selected for re-run.

20. The non-transitory computer readable medium of claim 19, wherein the instructions when executed, further cause the programmable device to perform functions of:
receiving, via the user interface, a user selection to re-run at least one of the first prompt and the one or more subsequent prompts;
constructing, via the prompt construction unit, a second prompt by appending the at least one of the first prompt and the one or more subsequent prompts to a second instruction string, the second instruction string including instructions to the generative model to generate a re-run digital content based on the at least one of the first prompt and the one or more subsequent prompts;
providing, via the prompt construction unit, as an input the second prompt to the generative model and receiving as an output the re-run digital content from the generative model; and
providing the re-run digital content to the client device to be presented on the user interface of the client device.
